(19) United States
(12) Patent Application Publication
(10) Pub. No.: US 2019/0020956 A1
(43) Pub. Date: Jan. 17, 2019

(54) ELECTROSTATIC MEMBRANE PUMP/TRANSDUCER SYSTEM AND METHODS TO MAKE AND USE SAME

(71) Applicant: Clean Energy Labs, LLC, Austin, TX (US)

(72) Inventor: Joseph F. Pinkerton, Austin, TX (US)

(73) Assignee: Clean Energy Labs, LLC, Austin, TX (US)

(21) Appl. No.: 15/647,073

(22) Filed: Jul. 11, 2017

(51) Int. Cl. H04R 19/02; H04R 1/40; H04R 7/06

(52) U.S. Cl. CPC H04R 19/02; H04R 2400/11; H04R 7/06; H04R 1/403

(57) ABSTRACT

Electrostatic venturi membrane-based pump/transducer systems and methods to make and use same. The motion of the membranes in the system is perpendicular to the net airflow produced by the electrostatic venturi membrane-based pump/transducer. The electrostatic venturi membrane-based pump/transducer systems can be arranged in cards, the cards can be stacked in arrays and operated at different electrical phases.

### CROSS-REFERENCE TO RELATED PATENT APPLICATIONS

This application is related to U.S. Pat. No. 9,516,426, issued Dec. 6, 2016 to Joseph F. Pinkerton, and entitled “Electrostatic Membrane Pump/Transducer And Methods To Make And Use Same” (“the Pinkerton '426 Patent”), which issued from U.S. patent application Ser. No. 14/857,179, filed Sep. 17, 2015, which was a continuation-in-part of U.S. patent application Ser. No. 14/047,813, filed Oct. 7, 2013, which is entitled “Electrically Conductive Membrane/Pump Transducer And Methods To Make And Use Same.” That application is a continuation-in-part of International Patent Application No. PCT/2012/058247, filed Oct. 1, 2012, which designated the United States and claimed priority to provisional U.S. Patent Application Ser. No. 61/541,779, filed on Sep. 30, 2011, each of which patent applications is entitled “Electrically Conductive Membrane Transducer And Methods To Make And Use Same.” All of these above-identified patent applications are commonly assigned to the Assignee of the present invention and are hereby incorporated herein by reference in their entirety for all purposes.

### TECHNICAL FIELD

The present invention relates to an electrostatic conductive membrane pump/transducer, and more particularly, electrostatic venturi membrane-based pump/transducer systems and methods to make and use same.

### BACKGROUND

Conventional audio speakers compress/heat and rarify/cool air (thus creating sound waves) using mechanical motion of a cone-shaped membrane at the same frequency as the audio frequency. Most cone speakers convert less than 10% of their electrical input energy into audio energy. These speakers are also bulky in part because large enclosures are used to muffle the sound radiating from the backside of the cone (which is out of phase with the front-facing audio waves). Cone speakers also depend on mechanical resonance; a large “woofer” speaker does not efficiently produce high frequency sounds, and a small “tweeter” speaker does not efficiently produce low frequency sounds.

Thermoacoustic (TA) speakers use heating elements to periodically heat air to produce sound waves. TA speakers do not need large enclosures or depend on mechanical resonance like cone speakers. However, TA speakers are terribly inefficient, converting well under 1% of their electrical input into audio waves.

The present invention relates to an improved transducer (i.e., speaker) that includes an electrically conductive membrane such as, for example, a polymer membrane. In some embodiments, the transducer can be an ultrasonic transducer. An ultrasonic transducer is a device that converts energy into ultrasound (sound waves above the normal range of human hearing). Examples of ultrasound transducers include a piezoelectric transducers that convert electrical energy into sound. Piezoelectric crystals have the property of changing size when a voltage is applied, thus applying an alternating current (AC) across them causes them to oscillate at very high frequencies, thereby producing very high frequency sound waves.

The location at which a transducer focuses the sound can be determined by the active transducer area and shape, the ultrasound frequency, and the sound velocity of the propagation medium. The medium upon which the sound waves are carries can be any gas or liquid (such as air or water, respectively).

Graphene membranes (also otherwise referred to as “graphene drums”) have been manufactured using a process such as disclosed in Lee et al. Science, 2008, 321, 385-388. PCT Patent Appl. No. PCT/US09/59266 (Pinkerton) (the “PCT US09/59266 Application”) described tunneling current switch assemblies having graphene drums (with graphene drums generally having a diameter between about 500 nm and about 1500 nm). PCT Patent Appl. No. PCT/US11/55167 (Pinkerton et al.) and PCT Patent Appl. No. PCT/US11/66497 (Everett et al.) further describe switch assemblies having graphene drums. PCT Patent Appl. No. PCT/US11/23618 (Pinkerton) (the “PCT US11/23618 Application”) described a graphene-drum pump and engine system.

The Pinkerton '426 Patent described and taught an electrostatic venturi membrane-based pump/transducer (“EVMP”) system (alternatively referred to as an “electrostatic membrane-based venturi pump/transducer system”), including as illustrated in FIGS. 1-2 and 3A-3F. These FIGS. 1-2 and 3A-3F correspond to FIGS. 26-27 and 28A-28F, respectively, in the Pinkerton '426 Patent (“the Pinkerton '426 Patent FIGS. 26-27 and 28A-28F”). FIG. 1 depicts an illustration of a side view of an enhanced and improved version of an electrostatic membrane-based venturi pump system (and audio speaker) 100 that includes twelve electrostatic membrane pump transducers (arranged in four column and three rows). The side view shows four of the electrostatic membrane pump transducers 100A-100D. FIG. 2 depicts illustrations of an overhead view of the illustration of the electrostatic membrane-based venturi pump system 100 and reflects the tops of the twelve electrostatic membrane pump transducers 100A-100L.

FIGS. 3A-3F depict illustrations of overhead views of an electrostatic membrane pump transducer (such as electrostatic membrane pump transducers 100A) at various levels. The six layers reflected in these levels are as follows:

An electrically conductive solid stator 103 with central hole 302, which has an overhead view depicted in FIG. 3C. Such electrically conductive solid stators 103 can be made of stainless steel.

Electrically conductive perforated stators 106, which has an overhead view depicted in FIG. 3F. The electrically conductive perforated stator 106 has multiple perforations 301. As shown in FIG. 1, electrostatic membrane pump transducers 100A has three levels of electrically conductive perforated stators 106. Such electrically conductive perforated stators 106 can be made of an electrically conductive material, such as stainless steel. In alternative embodiments, one of more of the electrically conductive perforated stators can be designed to have just one perforation (i.e., hole) that allows the fluid to flow from one side of an electrically conductive perforated stator to the other side of the electrically conductive perforated stator. For instance, the electrically conductive perforated stator can have one central hole similar to the electrically conductive solid stator 103, although the hole may be larger or offset.

Electrically conductive membrane frames 105, which has an overhead view depicted in FIG. 3E. As shown in FIG. 1, electrostatic membrane pump transducers 100A has seven instances of electrically conductive membrane frame 105. Such electrically conductive membrane frames 105 can be made of an electrically conductive material, such as stainless steel. The electrically conductive member frames 105 are frames that support the electrically conductive membranes 114 (shown in FIG. 1) and also electrically connect membranes 114 to an external electrical circuit. The electrically conductive membranes 114 can be made of Mylar coated with a slightly conductive material.

Insulating spacers 104, which overhead view is depicted in FIG. 3E. As shown in FIG. 1, electrostatic membrane pump transducers 100A has seven levels of insulating spacers 104. Such insulating spacers 104 can be made of an electrical insulator, such as fiberglass.

Insulating venturi spacer 102, which overhead view is depicted in FIG. 3B.

Venturi exit plate 101 with central hole 303 and optional nozzle (not shown), which overhead view is depicted in FIG. 3A.

As reflected in FIG. 1, each layer is stacked up along with the electrically conductive membranes 114. The layers are preferably joined together with some type of adhesive. Pre-cut (such as stamped out) sheets with multiple copies of each element can be assembled as a panel. FIG. 2 shows a panel with twelve electrostatic venturi membrane pumps. As noted above, electrically conductive perforated stators 106, electrically conductive solid stators 103, and the electrically conductive membrane frames 105 can be made of stainless steel, such as stainless steel that is laminated with two sheets of an insulating material like Mylar (which greatly reduces stator-stator and frame-stator sparking). (Voltages between a frame and stator can be a few to several kV).

As the electrically conductive membranes 114 move up (such as shown in electrostatic membrane pump transducer 100A in FIG. 1), an elevated pressure jet of air 110 (or other fluid as the case may be) is forced out of the hole 302 of electrically conductive solid stator 103, through the channel defined by the insulating venturi spacer 102, and through hole 303 of venturi exit plate 101. Because the velocity of the air increases as it moves from the top membrane chamber out hole 302 of electrically conductive solid stator 103, it creates a partial vacuum in the insulating venturi spacer 102 region and this draws in air 107 from the bottom of the device (on either side of the pump chamber). This air 107 combines with the high speed air jet exiting hole 302 of electrically conductive solid stator 103 and both exit out hole 303 of venturi exit plate 101.

Likewise, as electrically conductive membranes 114 move up (such as shown in electrostatic membrane pump transducer 100A in FIG. 1), air (or other fluid) moves upward in electrostatic membrane pump transducer 100A in FIG. 1 through perforations 301 of the electrically conductive perforated stators 106 such that the air (or other fluid) moves from the bottom side of an electrically conductive perforated stator 106 to the top side of the same electrically conductive perforated stator 106. Such movement of air (or other fluid) is shown by arrows 108. Sound or ultrasonic waves 112 are also produced by this movement of air.

When the motion of electrically conductive membrane 114 reverses (such as shown in electrostatic membrane pump transducer 100B in FIG. 1), air is drawn into the pump chamber of electrostatic membrane pump transducer 100B through hole 302 of electrically conductive solid stator 103. Such drawing of air into the pump chamber of electrostatic membrane pump transducer 100B through hole 302 of electrically conductive solid stator 103 also creates a vacuum that draws in more air 107. Moreover, air 107 has some inertia that makes it continue to move toward and out of hole 303 of venturi exit plate 101.

Likewise, as electrically conductive membranes 114 move down (such as shown in electrostatic membrane pump transducer 100B in FIG. 1), air (or other fluid) moves downward in electrostatic membrane pump transducer 100A in FIG. 1 through perforations 301 of the electrically conductive perforated stators 106 such that the air (or other fluid) moves from the top side of an electrically conductive perforated stator 106 to the bottom side of the same electrically conductive perforated stator 106. Such movement of air (or other fluid) is shown by arrows 109. Sound or ultrasonic waves 113 are also produced by this movement.

These two parts of the cycle result in a net pumping effect that draws air in from the bottom (or one side) and shoots it out the top (or the other side) of the device (this also creates a thrust in the opposite direction of the high speed air jet). The electrically conductive membranes 114 can operate at both sonic and ultrasonic frequencies. Ultrasonic frequencies are preferred due to higher pumping rates and the fact that the pumping sound is inaudible. By alternating the phase of half the electrostatic membrane pump transducers 100A-100L (180 degrees with respect to the other half), much of the sonic or ultrasonic sound of the pump array (as shown by sound or ultrasonic waves 112 and 113) can be cancelled out without affecting the net pumping rate.

The EVMP system 100 shown in FIGS. 1-2 and 3A-3F had pumps in series to increase pressure and flow through the venturi channel. The EVMP system 100 also has pumps operating out of phase to cancel unwanted ultrasonic signals emanating from the pumps. For each complete cycle of the membrane motion, there was one power stroke that created a large flow pulse and one return stroke that creates a small (or even reverse) flow pulse. Also, the front face of this EVMP was roughly equal to the surface area of the membranes. To double flow, this required doubling the face area of the EVMP, which resulted in a large face area for a given flow rate.

Accordingly, there are needs for an improved EVMP.

### SUMMARY OF THE INVENTION

The present invention relates to an electrically conductive membrane transducer. The electrically conductive membrane can be, for example, graphene membrane.

In general, in one aspect, the invention features an electrostatic venturi membrane-based pump (EVMP) that is operable to produce a net airflow along a first axis. The EVMP includes an electrically conductive membrane, a first frame, a first electrically conductive stator, a venturi plate, a second electrically conductive stator, and a second frame. The electrically conductive membrane operatively moves along a second axis. The first axis and second axis are substantially perpendicular.

Implementations of the invention can include one or more of the following features:

The first electrically conductive membrane can include a polymer.

The polymer can have a coating comprising a conductive material.

The first electrically conductive stator and the second electrically conductive stator can include stainless steel.

The stainless steel can be laminated with an electrically insulating film.

The first frame can hold the electrically conductive membrane. The first frame can include stainless steel.

The stainless steel can be laminated with an electrically insulating film.

Each of the first electrically conductive stator and the second electrically conductive stator can have a plurality of stator holes.

The first electrically conductive stator and the second electrically conductive stator can be operable to flow fluid out of at least one of the stator holes and into a venturi plate chamber that is an elevated pressure jet of fluid.

The fluid can be air.

The EVMP can be operable to create an audio signal.

In general, in another aspect, the invention features a stacked array of EVMPs. The EVMPs in the stacked array include the above described EVMPs.

In general, in another aspect, the invention features a device including a stacked array of electrostatic venturi membrane-based pump (EVMP) cards. Each of the EVMP cards include a plurality of EVMPs. The EVMPs in the plurality of EVMPs include an electrically conductive membrane, a first frame, a first electrically conductive stator, a venturi plate, a second electrically conductive stator, and a second frame. The EVMP cards in the stacked array of EVMP cards have a face area. The stacked array of the EVMP cards has a total face area that is the aggregate of the face areas of the EVMP cards. The electrically conductive membranes in the EVMP cards in the stacked array of EVMP cards have a membrane area. The stacked array of the EVMP cards has a total membrane area that is the aggregate of the membrane areas of the electrically conductive membranes in the EVMP cards of the stacked array of EVMP cards. The total membrane area is at least five times larger than the total face area.

Implementations of the invention can include one or more of the following features:

The device can include at least two stacked arrays of EVMP cards.

At least two stacked arrays of EVMP cards can be arranged in a parallel configuration.

The arrangement of the at least two stacked arrays of EVMP cards parallel to one another can be operable to increase airflow and to create an acoustic baffle.

At least one of the EVMP cards in the stacked array of EVMP cards can be driven by a voltage that is out of the phase to at least another of the EVMP cards of the stacked array of EVMP cards.

The device can include a first stacked array of EVMP cards, a second stacked array of EVMP cards, and a third stacked array of EVMP cards.

The first stacked array of EVMP cards, the second stacked array of EVMP cards, and the third stacked array of EVMP cards can be driven by voltages that are out of phase with each other.

The first stacked array of EVMP cards, the second stacked array of EVMP cards, and the third stacked array of EVMP cards can be driven by voltages that are out of phase with each other by around 120°.

The majority of the EVMPs in the first stacked array of EVMP cards, the second stacked array of EVMP cards, and the third stacked array of EVMP cards have at least two power strokes per cycle of the electrically conductive membrane of the EVMP.

At least some of the electrically conductive membranes of the EVMPs can be trough shaped.

The device can further include at least one conventional electrostatic membrane pump.

The at least one conventional electrostatic membrane pump can be operable as a tweeter.

The device can further include electronics and a battery.

The electrically conductive membranes of at least some of the EVMPs in the stacked array of EVMP cards can be operable to operate at ultrasonic frequencies.

The electrically conductive membranes of at least some of the EVMPs in the stacked array of EVMP cards can be operable to operate at sonic frequencies.

The device can be operable to create an audio signal.

The electronically conductive membranes of at least some of the EVMPs in the stacked array of EVMP cards can be operable to operate at ultrasonic frequencies to produce the audio signal.

The stacked array of EVMP cards can produce audio in the 20 Hz to 1000 Hz range.

EVMPs in the stacked array of EVMP cards can be operable to operate by moving the electrically conductive membranes in the EVMPs at a frequency greater than 20 kHz.

The device can be selected from a group consisting of cooling fans, propulsion devices, and audio speakers.

The EVMPs in the stacked array of EVMP cards can include a die stamped material.

The die stamped material can be a die stamped metal.

The die stamped metal can be sheet metal.

In general, in another aspect, the invention features a device that includes a stacked array of electrostatic venturi membrane-based pump (EVMP) cards. Each of the EVMP cards include a plurality of EVMPs. The EVMPs in the plurality of EVMPs include an electrically conductive membrane, a first frame, a first electrically conductive stator, a venturi plate; a second electrically conductive stator, and a second frame. The electrically conductive membrane is operable to move in a first direction along a first axis to perform a first power stroke. The electrically conductive membrane is operable to move in an opposite direction along the first axis to produce a second power stroke.

Implementations of the invention can include one or more of the following features:

The EVMP can be operable to produce a first net airflow along a second axis when the electrically conductive membrane performs the first power stroke. The EVMP can be operable to produce a second net airflow along a second axis when the electrically conductive membrane performs the second power stroke. The first axis and second axis are substantially perpendicular.

In general, in another aspect, the invention features a method that includes selecting a device that includes a stacked array of electrostatic venturi membrane-based pump (EVMP) cards. The method further includes producing a net airflow along a first axis by operating the EVMP cards to move electrically conductive membranes in the EVMPs in the stacked array of EVMP cards in a direction along a second axis. The first axis and the second axis are substantially perpendicular.

Implementations of the invention can include one or more of the following features:

At least some of the electrically conductive membranes in the EVMPs in the stacked array of EVMP cards can be operated at ultrasonic frequencies.

At least some of the electrically conductive membranes in the EVMPs in the stacked array of EVMP cards can be operated at sonic frequencies.

The step of producing the net airflow can create an audio signal.

At least some of the electrically conductive membranes in the EVMPs in the stacked array of EVMP cards are operated at ultrasonic frequencies to produce the audio signal.

The audio signal is in the 20 Hz to 1000 Hz range.

The EVMPs in the stacked array of EVMP cards can be operated by moving the electrically conductive membranes in the EVMPs at a frequency greater than 20 kHz.

The method can be performed by a device selected by a group consisting of cooling fans, propulsion devices, and audio speakers.

### DESCRIPTION OF DRAWINGS

FIG. 1 depicts an illustration from the Pinkerton '426 Patent FIG. 26, which is a side view of an enhanced and improved version of an electrostatic membrane-based venturi pump system (and audio speaker) that includes twelve electrostatic membrane pump transducers (arranged in four column and three rows).

FIG. 2 depicts an illustration from the Pinkerton '426 Patent FIG. 27, which is an overhead view of the illustration of the electrostatic membrane-based venturi pump system shown in FIG. 1.

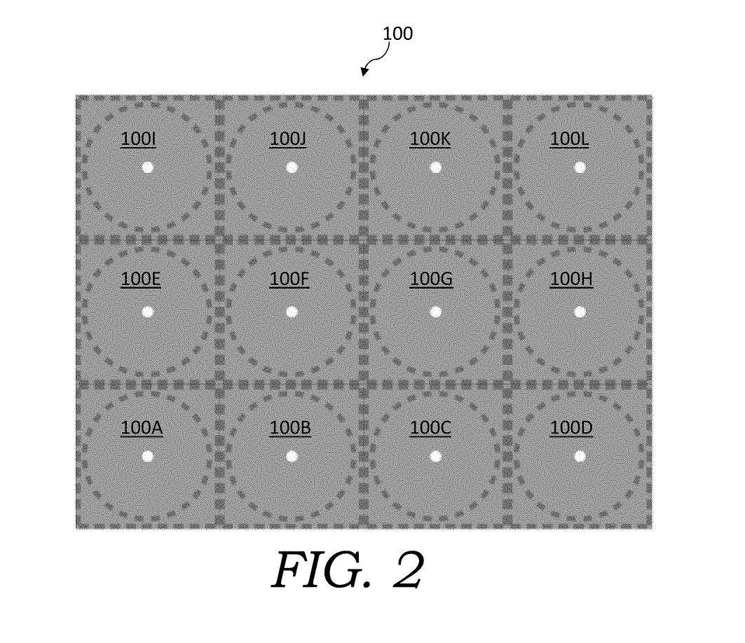

FIGS. 3A-3F depict illustrations from, respectively, the Pinkerton '426 Patent FIGS. 28A-28F, which are overhead views of the electrostatic membrane pump transducer shown in FIG. 1 at various levels.

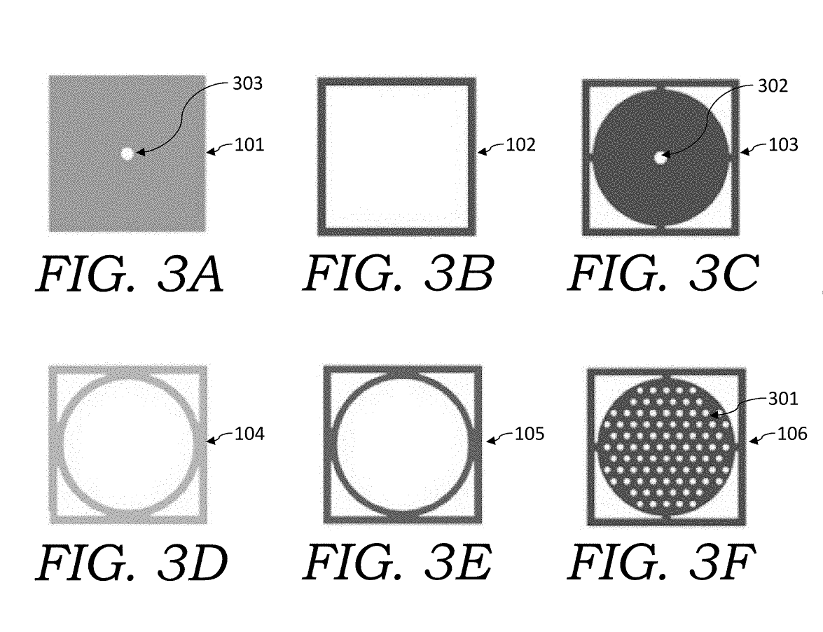

FIG. 4 illustrates an exploded view of an EVMP of the present invention.

FIGS. 5A-5B are illustrations showing airflow in an EVMP system of the present invention.

FIG. 6 is an illustration of one EVMP in an EVMP system of the present invention.

FIG. 7 is an illustration of the EVMP system in FIG. 5 taken from the view of A-A′ shown in FIG. 6.

FIG. 8A is an illustration of the EVMP system in FIG. 5 taken from the view of B-B′ shown in FIG. 6.

FIG. 8B is another illustration of the EVMP system in FIG. 5 taken from the view of B-B′ shown in FIG. 6.

FIG. 9 is an illustration of a speaker that utilizes EVMP card stacked arrays.

FIG. 10 is a graph that shows that using three stacks of EVMP card stacked arrays at different electrical phases will smooth out the airflow output and reduce the amount of unwanted ultrasonic airflow.

FIG. 11 is a graph that shows how the airflow output of the three stacks of EVMP card stacked arrays can be varied at 500 Hz while the EVMPs in the EVMP card stacked arrays are pumping at 25 KHz.

FIG. 12 is a graph that compares the single air pulse of the EVMP system shown in FIG. 1 compared to the two air pulses of the EVMP system of the present invention.

FIGS. 13A-13B are illustrations showing an EVMP card before and after trimming of its vent fingers for EVMP cards of the present invention.

### DETAILED DESCRIPTION

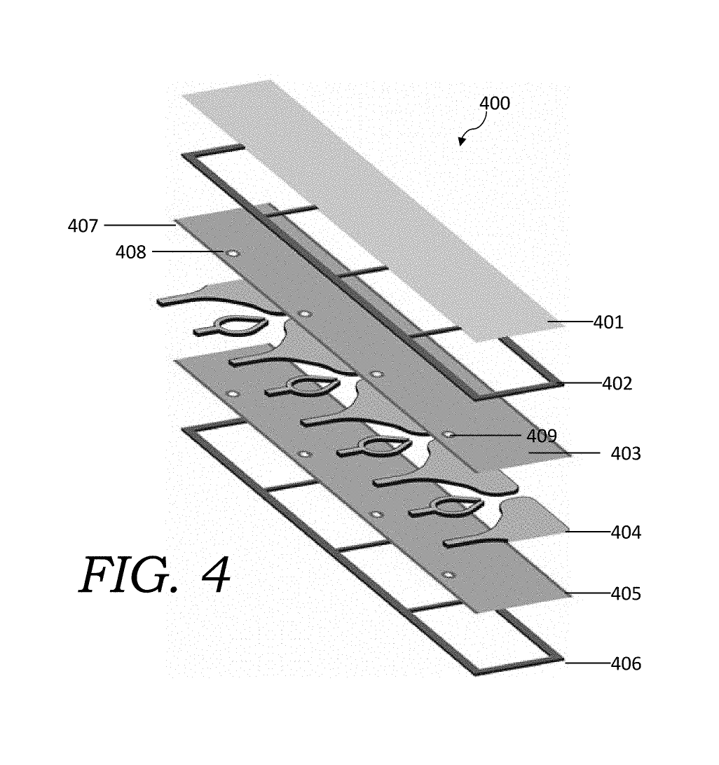

The present invention relates to improved electrostatic membrane-based venturi pumps/transducers (EVMP) and improved EVMP systems. FIG. 4 illustrates an exploded view of an EVMP 400 of the present invention. EVMP 400 has an electrically conductive membrane 401, a first frame 402, a first stator 403, a venturi plate 404 (that forms the venturi channel), a second stator 405, and a second frame 406. The gap between the membrane 401 and first stator 403 is on the order of about 50 microns (generally between about 25 microns to 100 microns) and the thickness of the venturi plate 404 is on the order of about 400 microns (generally between 200 microns and 800 microns). This width of the membrane 401 is between about 1 to 2 centimeters and its length is between about 10 to 30 centimeters. The first stator 403 and the second stator 405 can be made out of a metal, such as stainless steel or aluminum that is encapsulated in a polymer or other insulating material. The insulating polymer is illustrated in FIG. 4 by insulating polymer 407 on the edges of the stators and the insulating polymer 408 that encapsulates the hole edges of hole 409 of the stators. The venturi plate 404 can be made of an insulator, such as plastic. The first frame 402 and second frame 406 can be made of a stiff material, such as stainless steel or fiberglass.

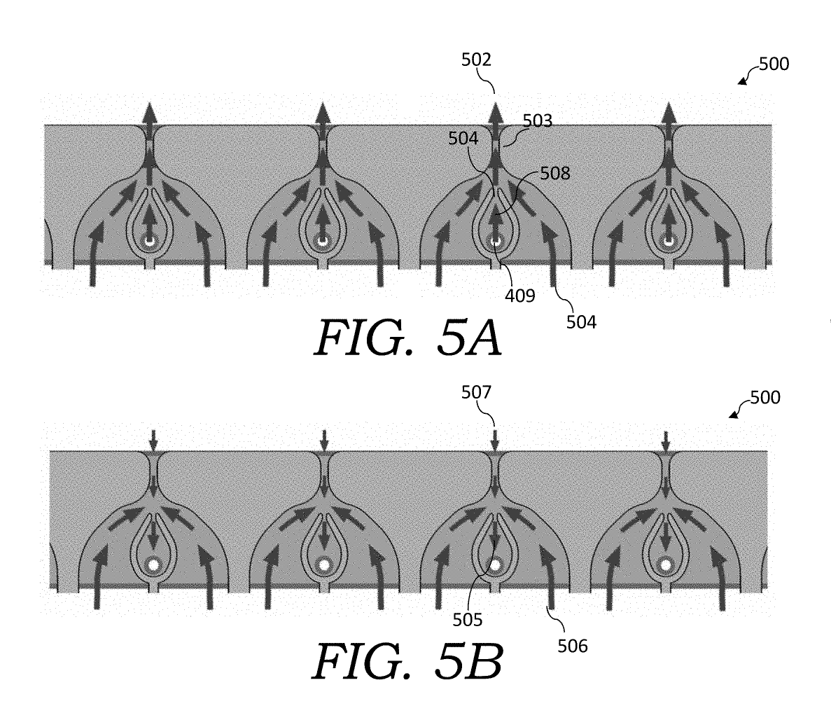

FIGS. 5A-5B are illustrations showing airflow in an EVMP system device 500 of the present invention. As shown in FIG. 5A, when the membrane 401 moves upward (i.e., toward the top of the device 500 as oriented in FIG. 5A), it forces air out of the stator hole 409 and this air is compressed into a venturi channel. An air jet 508 is accelerated through a constricted channel 504 and routed through exit channel 503. This air jet 508 and surrounding structure create a partial vacuum that draws air in from the back of the device (airflow from the back shown by arrows 504) and shoots it out the front of the device as combined air jet 502.

FIG. 5B shows the flow when the membrane 401 moves downward (i.e., toward the bottom of the device 500 as oriented in FIG. 5B). Air (shown by arrow 505) is forced down into the stator hole 409 which creates a partial vacuum and draws more air in from the back of the device (shown by arrows 506). Because the front exit channel 503 is narrow, much less air is drawn in from the front of the device (shown by arrow 507) than the back. Over a full membrane cycle, there is a net airflow from the back of the EVMP system device 500 to the front. “Net airflow” refers to the total airflow resulting from the EVMP system over a period of time, which period of time is generally a complete cycle of the EVMP system.

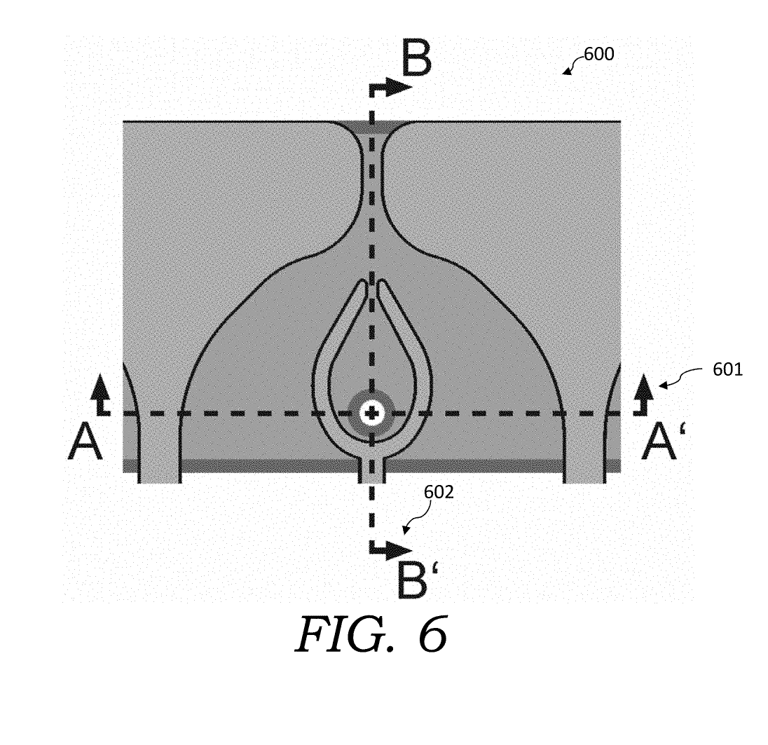

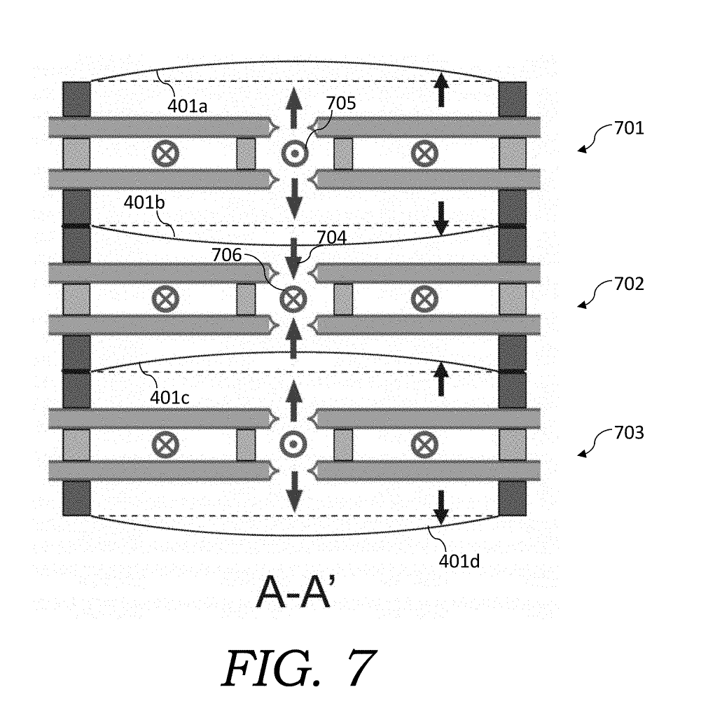

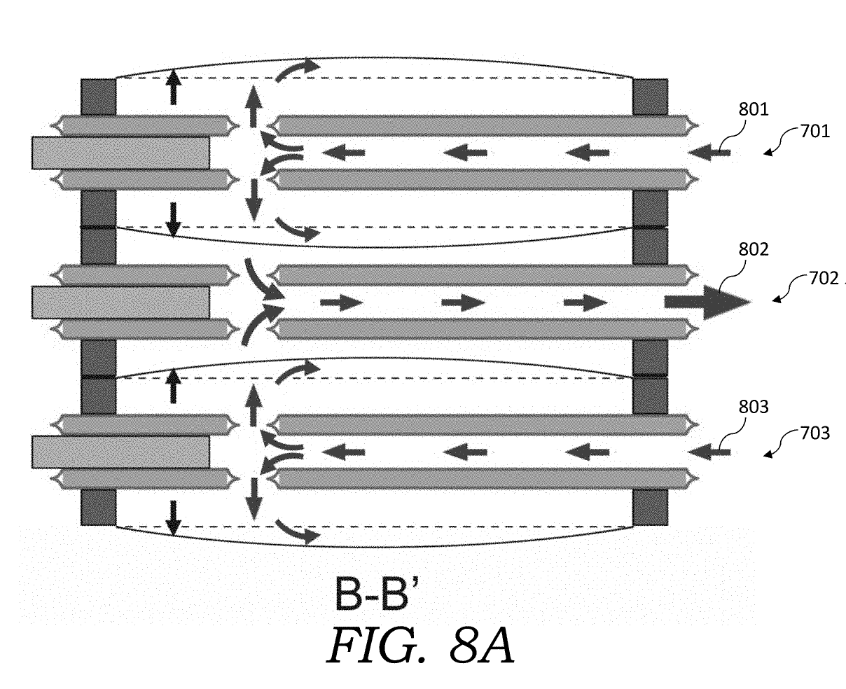

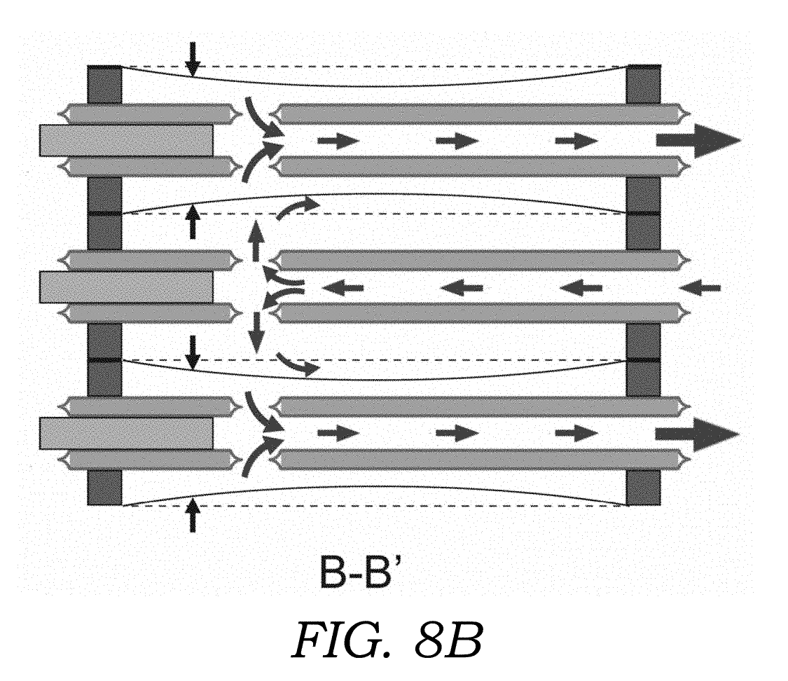

FIG. 6 is an illustration of one EVMP 600 in the EVMP system device 500. FIG. 6 indicates view 601 (view A-A′) and view 602 (view B-B′). FIG. 7 is an illustration of the EVMP system 500 taken from the view 601 (view A-A′). FIG. 8A-8B are illustrations of the EVMP system 500 taken from the view 602 (view B-B′). FIGS. 7 and 8A-8B show three stacked EVMPs (EVMPs 701-703).

As shown in FIG. 7, the membrane motion (of membranes 401a-401d) creates airflow within the venturi channels as shown by dot marks 705 (airflow out of the page) and “X” marks 706 (airflow into the page). The stators are encapsulated with an insulator (such as a polymer) to eliminate sparking between oppositely charged stators. Air is shown as being forced into the middle venturi channel (of EVMP 702) and creating an airflow as shown in FIG. 5A. The other two venturi channels (of EVMP 701 and 703) are drawing air in as shown in FIG. 5B. Each membrane 401a-401d completes on the order of about 25,000 full cycles per second (generally in the range between 20,000 to 50,000 cycles per second).

FIGS. 8A-8B show how the membrane motion (of membranes 401a-401d) creates airflow within the venturi channels. For FIG. 8A, air is shown as being forced into the middle venturi channel (of EVMP 702) and creates the airflow as shown in FIG. 5A. The other two venturi channels (of EVMP 701 and 703) are drawing air in as shown in FIG. 5B. For FIG. 8B, air is shown as being drawn in the middle venturi channel (of EVMP 702) and creates the airflow as shown in FIG. 5B. Air is being forced into the other two venturi channels (of EVMP 701 and 703) as shown in FIG. 5A.

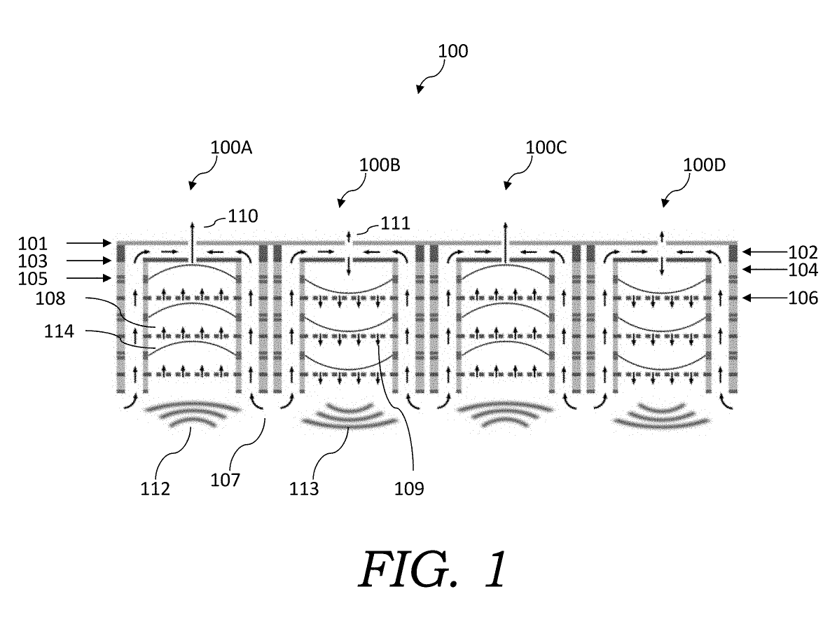

As shown in FIG. 8A, membranes 401b and 401c are creating a power stroke in the middle venturi channel (of EVMP 702) during the first half of their cycle (the black arrows show the direction of membrane motion). As shown in FIG. 8B, in the second half of their cycle, the membranes 401b and 401c are creating power strokes for the other two venturi channels (of EVMP 701 and 703). Thus, for one complete membrane cycle, the membranes 401a-401d create two power strokes instead of the one power stroke per cycle in EVMP 100 shown in FIG. 1. As can be seen in FIG. 8A, the ultrasonic pulsed airflow through the middle Venturi channel (of EVMP 702) as shown by the large arrow 802 is partially canceled by the oppositely directed airflow of the other two Venturi channels (of EVMP 701 and 703) as depicted by the two smaller arrows 801 and 803.

“Net airflow” refers to the total airflow resulting from the EVMPs in the EVMP system. For example, for EVMP 701, there are various arrows showing the airflow, such as arrows 804a-804b, 805a-805b, 806a-806b, and 807 shown in FIG. 8A. Relative to the orientation of EVMP 701 in FIGS. 8A-8B, the vertical flow component shown by these arrows cancels over time each other (i.e., over a complete cycle of the EVMP system) such that this vertical flow component is cancelled over time). Air exits the stator holes at one time and then enters the stator holes at another time such that there is zero average vertical flow through the stator holes, which yields no net flow in the vertical direction. Per the orientation of FIGS. 8A-8B, the vertical components of the air flows cancel each other, thereby leaving a net airflow in a horizontal direction (which is perpendicular to the movement of the membranes of EVMPs 701-703).

EVMP system 500 can be used to create an audio signal by modulating its pumped airflow at audio frequencies. Since the membrane of the EVMP 600 is operated at around 25 kHz it can, for example, complete 250 full pumping cycles for each one cycle of a 100 Hz audio signal.

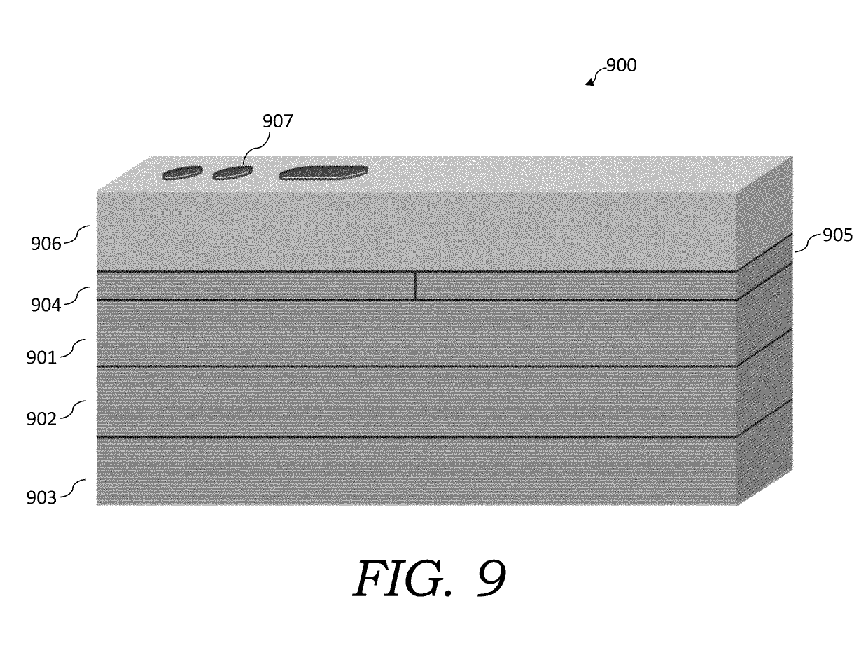

FIG. 9 shows a speaker 900 that utilizes EVMP card stacked arrays 901-903. Each of the EVMP card stacked arrays has a face area, such as front face area of EVMP card stacked array 903. Each of EVMP card stacked array 901-903 has two face areas, on one side of speaker 900 (such as front face area for EVMP card stacked array 903) and the other side of the speaker 900 (which is hidden in the view of FIG. 9). Air enters and exits the EVMP card stacked arrays through each of the EVMP card stacked array face areas (In fact air enters and exits the EVMPs in the EVMP card stacked arrays through each of the face areas of the EVMP cards.

By way of example, the EVMP card stacked array 901 can be a stacked array of 30 cards. Each card in the EVMP card stacked array can be about 1 mm thick so the EVMP card stacked array 901 stack of cards is about 30 mm thick. The face area of one EVMP card (in the EVMP card stacked array) is 1 mm times the stack width (for example 300 mm), which calculates to be 300 mm² per card for each face of the EVMP card (which means the combined area of the faces of an EVMP card in the EVMP card stacked array is 600 mm² per EVMP card). Thus, for an EVMP card stacked array having 30 cards, this calculates to be 18,000 mm² for the total face area of the EVMP card stacked array. I.e., the area of front face area would be 9,000 mm², as it is one of the two faces of EVMP card stacked array 903.

The membrane area of that same EVMP card is the depth of the card (for example 20 mm) times the card width (which, again, for example, is 300 mm). This calculates to be 6,000 mm² per EVMP card, which is 10 times larger than the face area of the EVMP card. Again, for a 30 card stacked array in an EVMP card stacked array, this calculates to a total membrane area of 180,000 mm². This means that total membrane area of the EVMP card stacked array (such as EVMP card stacked array 903) is around 10 times the total face area of the EVMP card stacked array. It is worthwhile to note that speaker 900 shows three EVMP card stacked arrays (namely EVMP card stacked arrays 901-903), which can be run at different electrical phases.

The speaker 900 also utilizes two (one for each of the two stereo channels) “conventional” electrostatic audio actuator card stacks 904-905 (conventional in that the membrane pumping frequency equals the produced audio frequency). I.e., conventional card stacks 904-905 are stacks of electrostatic tweeter cards. The speaker 900 also includes electronics and battery 906 with control buttons 907. Speaker 900 has three EVMP card stacked arrays 901-903, and although all of the cards within these EVMP card stack arrays are similar in structure, each EVMP card stack arrays can be driven at a different electrical phase. For instance, the EVMPs in each of EVMP card stacked arrays 901-903 can have an electrical drive voltage phase of 0°, 120°, and 240°, respectively. I.e., the EVMPs in EVMP card stacked array 901 can be operated at 0°, the EVMPs in EVMP card stacked array 902 can be operated at 120°, and the EVMPs in EVMP card stacked array 903 can be operated at 240°.

Accordingly, the EVMP card stacked arrays in the system of the present invention have a face area that is much smaller than its membrane area and the net airflow is perpendicular to the membrane motion. As shown above, the EVMPs in the EVMP card stacked arrays in the system of the present invention also have two power strokes per membrane cycle instead of one (approximately doubling airflow). Another advantage of the EVMPs in the EVMP card stacked arrays in the system of the present invention is that the membranes can be trough shaped instead of round so they can pump more air for a given length of pump.

These three elements together surprisingly resulted in a 20 to 50 fold increase in pumped airflow for a given device face size.

Another advantage is that the venturi flow channels can be greater than ten times longer than for EVMP 100 (disclosed and taught in the Pinkerton '426 Patent), which results in more efficient operation with less unwanted audio noise.

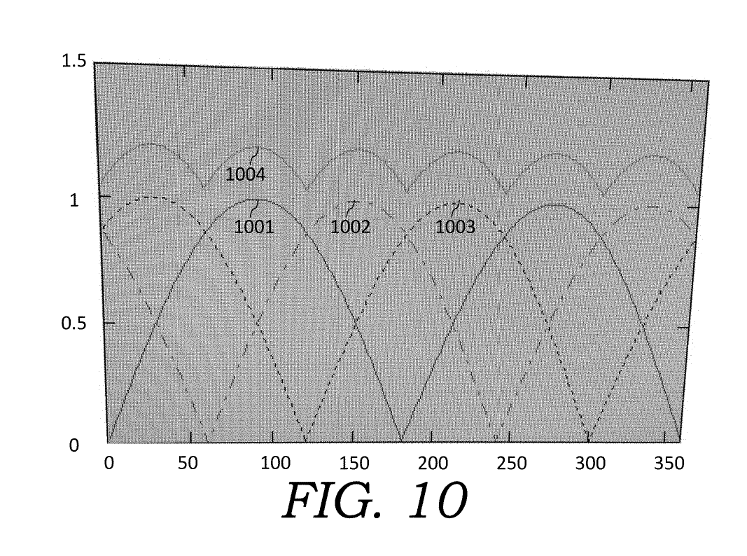

FIG. 10 is a graph that shows that using three EVMP card stack arrays (such as EVMP card stacked arrays 901-903) at different electrical phases of 0°, 120°, and 240°, respectively, will smooth out the airflow output and reduce the amount of unwanted ultrasonic airflow. The pulsed airflow of EVMP card stacked arrays 901-903 is shown in airflow curves 1001-1003, respectively. Although just one phase can be used for the EVMP card stacked arrays (such as shown in airflow curve 1001), the pulsed airflow creates unwanted ultrasound. When using three phases, the combined airflow output produces less ultrasound and looks like airflow curve 1004 (which has been scaled down to fit on the same graph as the other curves), which is the aggregate pulsed airflow of EVMP card stacked arrays 901-903.

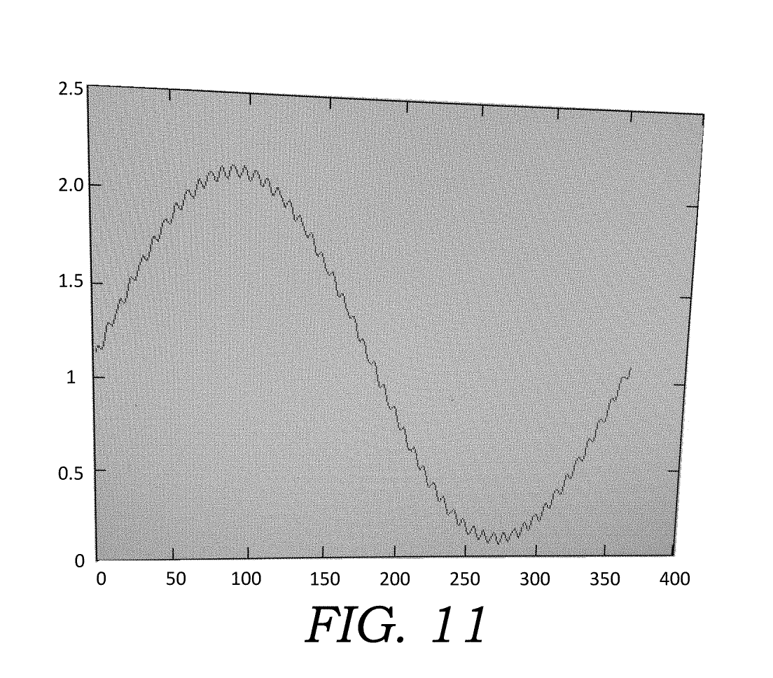

FIG. 11 shows how the output of the three EVMP card stacked arrays (such as EVMP card stacked arrays 901-903) can be varied (such as at 500 Hz) while the EVMP card stacked arrays are pumping air at around 25 kHz. The pumping frequency of the EVMPs in the EVMP card stacked arrays will typically be 20 to 50 kHz. The 25 kHz ripple on top of the 500 Hz airflow/audio signal is outside the range of human hearing and so does not degrade the quality of the music that is being reproduced.

The EVMP card stacked arrays 901-903 can produce audio in the 20 Hz to about 1000 Hz range (while the EVMPs are operating at approximately 25 kHz). For frequencies higher than about 1000 Hz, other types of electroacoustic actuators can be used such as the electrostatic tweeter card stacks 904-905 in speaker 900. In addition to producing 1 to 20 kHz audio signals, these electrostatic tweeter card stacks 904-905 can simultaneously produce ultrasonic signals on the order of 25 kHz to help cancel out any remaining ultrasound from the EVMP card stacked arrays 901-903 (by producing ultrasound that is 180 degrees out of phase with the ultrasound produced by the EVMP card stacked arrays 901-903).

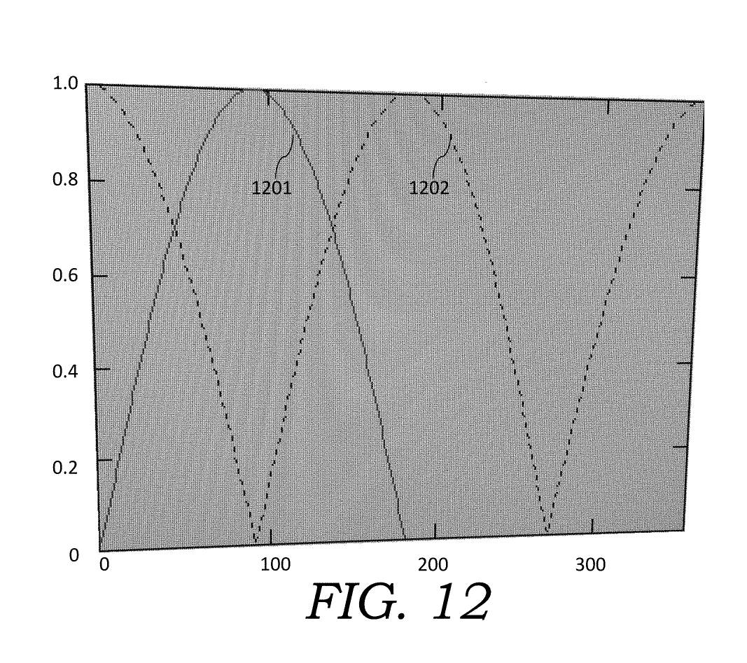

FIG. 12 is a graph that compares the airflow 1201 of EVMP system 100 (of the Pinkerton '426 Patent) as compared airflow 1202 of the EVMP system of card stack 901 per membrane cycle. Airflow 1201 reflects that EVMP system 100 has one power stroke per 360 degree membrane cycle. Airflow 1202 reflects that the present invention has two power strokes per 360 degree membrane cycle. Doubling the number of power strokes per membrane cycle roughly doubles the net airflow and increases audio power by a factor of four. This also helps to smooth out the airflow (generating less unwanted ultrasound).

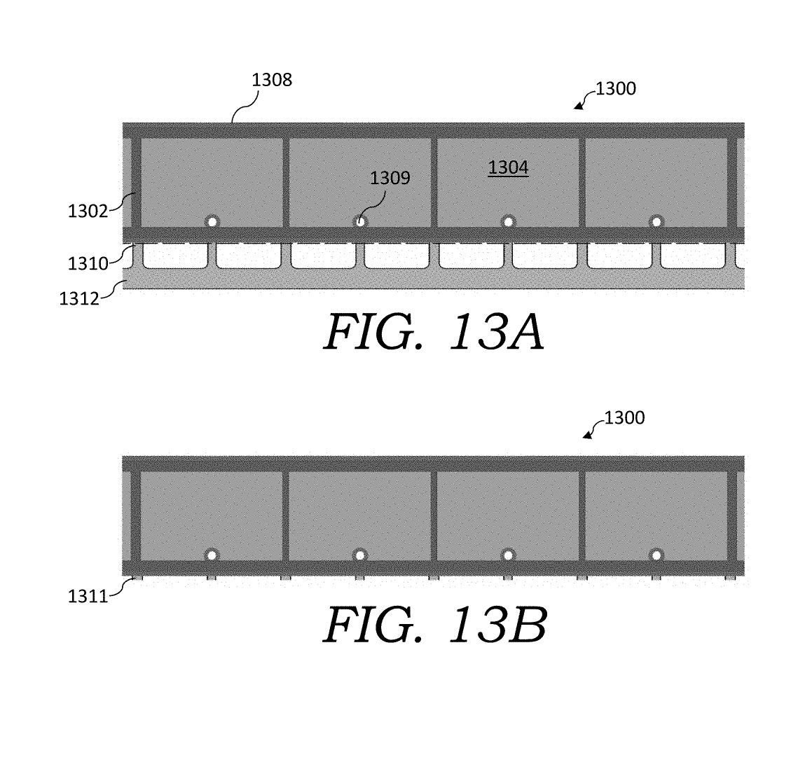

FIGS. 13A-13B are illustrations showing an EVMP card 1300 before and after trimming its vent fingers for EVMP cards of the present invention. As shown in FIG. 13A, the EVMP card 1300 includes a first frame 1302, a first stator 1304 having holes 1309 (with polymer 1308 coating the first stator), and venturi plate 1310 that will form the venturi channel, which includes a temporary support 1312. EVMP card 1300 has a second stator and second frame, which cannot be not seen in this viewpoint of FIGS. 13A-13B.

FIG. 13B shows EVMP card 1300 after trimming off the temporary support 1312 to form the vent fingers 1311 of the venturi plate. U.S. patent Ser. No. 14/717,715, filed May 20, 2015 to Pinkerton et al., entitled “Compact Electroacoustic Transducer And Loudspeaker System and Method of Use Thereof” (“the Pinkerton '715 Application”) discloses and describes process steps that can be utilized in conjunction hereto to manufacture the EVMP cards as shown in FIGS. 13A-13B. The Pinkerton '715 Application is hereby incorporated by reference in its entirety for all purposes.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. An electrostatic venturi membrane-based pump (EVMP) that is operable to produce a net airflow along a first axis, wherein the EVMP comprises:
(a) an electrically conductive membrane;
(b) a first frame;
(c) a first electrically conductive stator;
(d) a venturi plate;
(e) a second electrically conductive stator; and
(f) a second frame, wherein
(i) the electrically conductive membrane operatively moves along a second axis, and
(ii) the first axis and second axis are substantially perpendicular.

2. The EVMP of claim 1, wherein the first electrically conductive membrane comprises a polymer.

3. The EVMP of claim 2, wherein the polymer has a coating comprising a conductive material.

4. The EVMP of claim 1, wherein the first electrically conductive stator and the second electrically conductive stator comprise stainless steel.

5. The EVMP of claim 4, wherein the stainless steel is laminated with an electrically insulating film.

6. The EVMP of claim 1, wherein
(a) the first frame holds the electrically conductive membrane, and
(b) the first frame comprises stainless steel.

7. The EVMP of claim 6, wherein the stainless steel is laminated with an electrically insulating film.

8. The EVMP of claim 1, wherein each of the first electrically conductive stator and the second electrically conductive stator has a plurality of stator holes.

9. The EVMP of claim 8, wherein the first electrically conductive stator and the second electrically conductive stator are operable to flow fluid out of at least one of stator holes and into a venturi plate chamber that is an elevated pressure jet of fluid.

10. The EVMP of claim 9, wherein the fluid is air.

11. The EVMP of claim 1, wherein the EVMP is operable to create an audio signal.

12. A stacked array of EVMPs, wherein the EVMPs in the stacked array comprises the EVMPs of claim 1.

13. A device comprising a stacked array of electrostatic venturi membrane-based pump (EVMP) cards wherein each of the EVMP cards comprise a plurality of EVMPs and the EVMPs in the plurality of EVMPs comprise:
(a) an electrically conductive membrane;
(b) a first frame;
(c) a first electrically conductive stator;
(d) a venturi plate;
(e) a second electrically conductive stator; and
(f) a second frame, wherein
(i) the EVMP cards in the stacked array of EVMP cards have a face area,
(ii) the stacked array of the EVMP cards has a total face area that is the aggregate of the face areas of the EVMP cards,
(iii) the electrically conductive membranes in the EVMP cards in the stacked array of EVMP cards have a membrane area,
(iv) the stacked array of the EVMP cards has a total membrane area that is the aggregate of the membrane areas of the electrically conductive membranes in the EVMP cards of the stacked array of EVMP cards, and
(v) the total membrane area is at least five times larger than the total face area.

14. The device of claim 13, wherein the device comprises at least two stacked arrays of EVMP cards.

15. The device of claim 14, wherein at least two stacked arrays of EVMP cards are arranged in a parallel configuration.

16. The device of claim 15, wherein the arrangement of the at least two stacked arrays of EVMP cards parallel to one another is operable to increase airflow and to create an acoustic baffle.

17. The device of claim 13, wherein at least one of the EVMP cards in the stacked array of EVMP cards is driven by a voltage that is out of the phase to at least another of the EVMP cards of the stacked array of EVMP cards.

18. The device of claim 17, wherein the device comprises a first stacked array of EVMP cards, a second stacked array of EVMP cards, and a third stacked array of EVMP cards.

19. The device of claim 18, wherein the first stacked array of EVMP cards, the second stacked array of EVMP cards, and the third stacked array of EVMP cards are driven by voltages that are out of phase with each other.

20. The device of claim 19, wherein the first stacked array of EVMP cards, the second stacked array of EVMP cards, and the third stacked array of EVMP cards are driven by voltages that are out of phase with each other by around 120°.

21. The device of claim 19, wherein the majority of the EVMPs in the first stacked array of EVMP cards, the second stacked array of EVMP cards, and the third stacked array of EVMP cards have at least two power strokes per cycle of the electrically conductive membrane of the EVMP.

22. The device of claim 13, wherein at least some of the electrically conductive membranes of the EVMPs are trough shaped.

23. The device of claim 13 further comprising at least one conventional electrostatic membrane pump.

24. The device of claim 23, wherein the at least one conventional electrostatic membrane pump is operable as a tweeter.

25. The device of claim 24 further comprising electronics and a battery.

26. The device of claim 13, wherein the electrically conductive membranes of at least some of the EVMPs in the stacked array of EVMP cards are operable to operate at ultrasonic frequencies.

27. The device of claim 13, wherein the electrically conductive membranes of at least some of the EVMPs in the stacked array of EVMP cards are operable to operate at sonic frequencies.

28. The device of claim 13, wherein the device is operable to create an audio signal.

29. The device of claim 28, wherein the electronically conductive membranes of at least some of the EVMPs in the stacked array of EVMP cards are operable to operate at ultrasonic frequencies to produce the audio signal.

30. The device of claim 13, wherein the stacked array of EVMP cards produces audio in the 20 Hz to 1000 Hz range.

31. The device of claim 30, wherein EVMPs in the stacked array of EVMP cards are operable to operate by moving the electrically conductive membranes in the EVMPs at a frequency greater than 20 kHz.

32. The device of claim 13, wherein the device is selected from a group consisting of cooling fans, propulsion devices, and audio speakers.

33. The device of claim 13, wherein the EVMPs in the stacked array of EVMP cards comprises a die stamped material.

34. The device of claim 33, wherein the die stamped material is a die stamped metal.

35. The device of claim 34, wherein the die stamped metal is sheet metal.

36. A device comprising a stacked array of electrostatic venturi membrane-based pump (EVMP) cards wherein each of the EVMP cards comprise a plurality of EVMPs and the EVMPs in the plurality of EVMPs comprise:
(a) an electrically conductive membrane;
(b) a first frame;
(c) a first electrically conductive stator;
(d) a venturi plate;
(e) a second electrically conductive stator; and
(f) a second frame, wherein
(i) the electrically conductive membrane is operable to move in a first direction along a first axis to perform a first power stroke,
(ii) the electrically conductive membrane is operable to move in an opposite direction along the first axis to produce a second power stroke.

37. The device of claim 36, wherein
(a) the EVMP is operable to produce a first net airflow along a second axis when the electrically conductive membrane performs the first power stroke;
(b) the EVMP is operable to produce a second net airflow along a second axis when the electrically conductive membrane performs the second power stroke; and
(c) the first axis and second axis are substantially perpendicular.

38. A method comprising:
(a) selecting a device comprising a stacked array of electrostatic venturi membrane-based pump (EVMP) cards;
(b) producing a net airflow along a first axis by operating the EVMP cards to move electrically conductive membranes in the EVMPs in the stacked array of EVMP cards in a direction along a second axis, wherein the first axis and the second axis are substantially perpendicular.

39. The method of claim 38, wherein at least some of the electrically conductive membranes in the EVMPs in the stacked array of EVMP cards are operated at ultrasonic frequencies.

40. The method of claim 38, wherein at least some of the electrically conductive membranes in the EVMPs in the stacked array of EVMP cards are operated at sonic frequencies.

41. The method of claim 38, wherein the step of producing the net airflow creates an audio signal.

42. The method of claim 41, wherein at least some of the electrically conductive membranes in the EVMPs in the stacked array of EVMP cards are operated at ultrasonic frequencies to produce the audio signal.

43. The method of claim 42, wherein the audio signal is in the 20 Hz to 1000 Hz range.

44. The method of claim 42, wherein the EVMPs in the stacked array of EVMP cards are operated by moving the electrically conductive membranes in the EVMPs at a frequency greater than 20 kHz.

45. The method of claim 38, wherein the method is performed by a device selected by a group consisting of cooling fans, propulsion devices, and audio speakers.
